(19) United States
(12) Patent Application Publication
(10) Pub. No.: US 2004/0181607 A1
(43) Pub. Date: Sep. 16, 2004

(54) Method and apparatus for providing information in a peer-to-peer network

(76) Inventors: Zhichen Xu, Sunnyvale, CA (US); Mallik Mahalingam, Sunnyvale, CA (US); Chunqiang Tang, Rochester, NY (US)

Correspondence Address: HEWLETT-PACKARD COMPANY, Intellectual Property Administration, P.O. Box 272400, Fort Collins, CO, 80527-2400, US

(21) Appl. No.: 10/386,454

(22) Filed: Mar. 13, 2003

(51) Int. Cl. G06F 15/173

(52) U.S. Cl. 709/239

(57) ABSTRACT

In a method of providing information in a peer-to-peer network, a query is received and a profile is generated based on the query by applying a latent semantic indexing algorithm. The profile is routed to a selected node based on the profile falling within a zone owned by the selected node.

### FIELD

This invention relates generally to network systems. More particularly, the invention relates to peer-to-peer networks.

### DESCRIPTION OF THE RELATED ART

Today, the Internet is the single most important information source that affects our everyday lives. The Internet, advantageously makes available enormous amounts of information at our finger tips, however, the Internet poses a tremendous challenge with respect to obtaining desired information in a timely manner.

Search engines, such as GOOGLE, only partially solve this problem by collecting documents on the Internet and using information retrieval (IR) algorithms to rank them. Search engines, however, cannot guarantee timely access to relevant information. Because of the size of the Internet and the large quantity of information, search engines typically take months to crawl the Web and update indices used for searching the Internet for desired information. Also, conventional search engines typically index only 1/10 or 1/1000 of the entire Internet contents. Furthermore, users that are concerned with obtaining the latest information have to frequently revisit search engines for possible updates.

Peer-to-peer (P2P) systems have been proposed as a solution to the problems associated with conventional centralized search engines. P2P systems offer advantages such as scalability, fault tolerance, and self-organization. These advantages spur an interest in building a decentralized information retrieval (IR) system based on P2P systems.

However, current P2P searching systems may also have disadvantages and drawbacks. For instance, P2P searching systems are typically unscalable or unable to provide deterministic performance guarantees. More specifically, the current P2P searching systems are substantially based on centralized indexing, query flooding, index flooding or heuristics. As such, centralized indexing systems, such as Napster, suffer from a single point of failure and performance bottleneck at the index server. Flooding-based techniques, such as Gnutella, send a query or index to every node in the P2P system, and thus, consuming large amounts of network bandwidth and CPU cycles. Heuristics-based techniques try to improve performance by directing searches to only a fraction of the population but may fail to retrieve relevant documents.

One class of P2P systems, the distributed hash table (DHT) systems (e.g., content addressable network) provide an improved scalability over the other P2P systems. However, DHT systems are not without disadvantages and drawbacks. Since they offer a relatively simple interface for storing and retrieving information, DHT systems are not suitable for full-text searching.

Moreover, besides the performance inefficiencies, a common problem with typical P2P systems is that they do not incorporate advanced searching and ranking algorithms devised by the IR community. Accordingly, the P2P systems typically rely on simple keyword based searching. In this regard, conventional P2P systems typically return large amounts of unwanted information. Searching through this excess information wastes time and resources.

### SUMMARY

An embodiment pertains to a method of providing information in a peer-to-peer network. The method includes receiving a query and generating a profile based on applying a latent semantic indexing algorithm to the query. The method also includes routing the profile to a selected node based on the profile falling within a zone owned by the selected node.

Another embodiment relates to an apparatus for providing information in a peer-to-peer network. The apparatus includes means for implementing an overlay network by a group of peers of the peer-to-peer network and means for dividing the overlay network into zones, each peer of the group of peers owning a respective node. The apparatus also includes means for generating a profile based on applying a latent semantic indexing algorithm on a received query and means for routing the profile to a selected peer based on the profile falling within a respective of the selected peer.

Yet another embodiment pertains to a system for providing information in a peer-to-peer network. The system includes a plurality of peers and an overlay network implemented by the plurality of peers. The overlay network is configured to be divided into zones, each zone owned by a respective peer of the plurality of peers. The system also includes a plurality of indices, where each index of the plurality of indices based on at least one key pair comprising of a respective semantic vector and associated address index. The system further includes a profile module stored an executed by each peer of the plurality of peers. The profile module is configured to store a profile and to apply the profile to arriving information.

Yet another embodiment relates to a computer readable storage medium on which is embedded one or more computer programs. The one or more computer programs implement a method of for providing information in a peer-to-peer network. The one or more computer programs comprising a set of instructions for receiving a query and generating a profile based on applying a latent semantic indexing algorithm to the query. The instructions also include routing the profile to a selected node based on the profile falling within a zone owned by the selected node.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a representation of an embodiment;

FIG. 2 illustrates a logical perspective of another embodiment;

FIG. 3 illustrates an exemplary architecture for a peer search node in accordance with yet another embodiment;

FIG. 4 illustrates an exemplary routing table for a peer search module in accordance with yet another embodiment;

FIG. 5 illustrates an exemplary flow diagram for a query module of the peer search node shown in FIG. 3 in accordance to yet another embodiment;

FIG. 6 illustrates an exemplary flow diagram for a routing module of the peer search node shown in FIG. 3 in accordance with yet another embodiment;

FIG. 7 illustrates an exemplary flow diagram for an index module of the peer search node shown in FIG. 3 in accordance with yet another embodiment;

FIG. 8 illustrates an exemplary flow diagram for a profile module of the peer search node shown in FIG. 3 in accordance with yet another embodiment;

FIG. 9 illustrates a key to FIGS. 9A-B;

FIGS. 9A-B collectively illustrate an exemplary flow diagram for a profile module of the peer search node shown in FIG. 3 in accordance with yet another embodiment;

FIG. 10 illustrates an exemplary flow diagram for a profile module of the peer search node shown in FIG. 3 in accordance with yet another embodiment; and

FIG. 11 illustrates an exemplary computer system where an embodiment may be practiced.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of network systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment, a profile module may be provided in a peer search network to furnish selected information to a user. For example, instead of requiring users to constantly check for new contents, information filtering and dissemination systems take over this responsibility. These systems allow users to register persistent queries (e.g., user profiles). The systems detect new contents, match the new contents against the persistent queries, and continuously notify users when relevant information becomes available. We illustrate the use of such systems using a science project as an example. At the beginning of a project, scientists use search engines to find related work and manually select out the most relevant papers. Besides adding these papers to their bibliography, the scientists also register persistent queries (profiles) to have the systems notify them when documents similar to those papers are available. As a result, the scientists are constantly informed about relevant papers, discussions in news groups, etc., which allows the scientists to stay at the cutting edge of their fields. After drafting a technical paper, a scientist can register another profile to ask the systems to provide notification when the technical paper is cited.

A subset of peers (or nodes) of a peer-to-peer (P2P) network implement a peer search network that can search with user profiles and perform other search and retrieve functions. A logical space formed by the peer search network may be a Cartesian space (e.g., d-torus), where d is the dimension of the logical space. The logical space is divided into fundamental (or basic) zones where each node of the subset is the peers is an owner. Additional zones are formed over the fundamental zones.

In the peer search network, information (e.g., documents, web pages, data, etc.) may be represented by a key pair comprising a vector and an address index (e.g., the information itself, a universal resource locator, a network address, etc.). In one embodiment, the vector may be a term vector based on a vector space modeling algorithms. In another embodiment, the vector may be a semantic vector, S, which may be a semantic information space representation of a selected item of information. The semantic vector may be determined by applying a latent-semantic indexing (LSI) algorithm. In other embodiments, the vector may use any IR algorithm that can derive a vector representation of information. The vector also indicates a location in the peer search network. The key pair is then routed to the node owner of the zone where the vector falls in the peer search network. Indices based on similar key pairs may then be formed at a node or around nearby neighboring nodes

In accordance with another embodiment, the profile module may receive a query generated by a query initiator, i.e., a subscriber. The profile module may then map the query into a semantic information space as a profile by applying LSI algorithms. The profile is then routed to a selected node in a peer search network based on the profile falling within a zone owned by the selected node. At the selected node, the profile may be distributed within a group of neighboring nodes within a profile radius of the selected node. As information is received at nodes, the nodes may compare the received information with the stored profiles. If the received information matches any of the stored profiles, the matching information may then be forwarded to the respective subscribers.

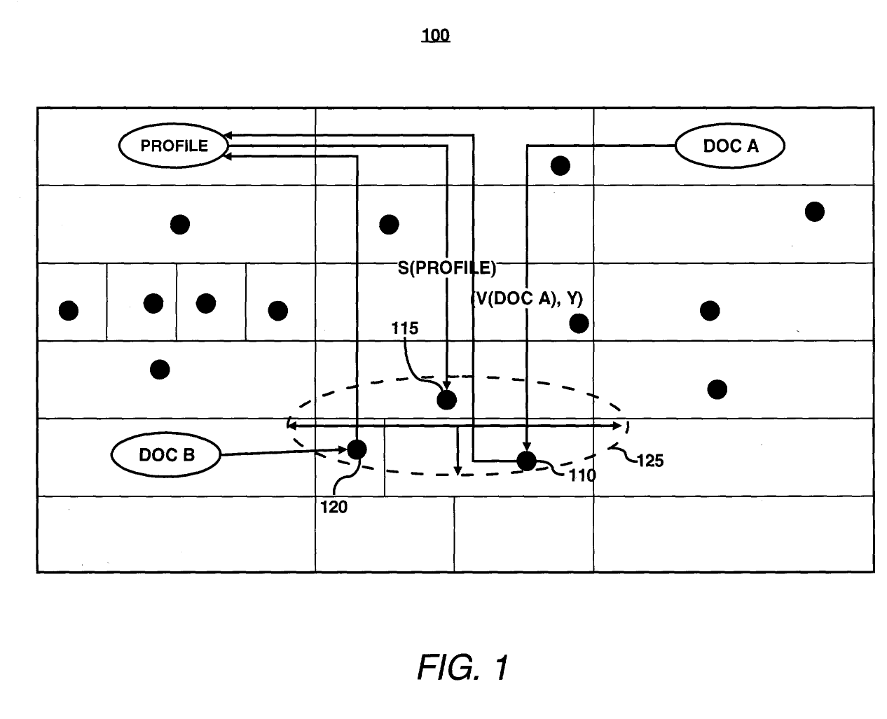

FIG. 1 illustrates a logical diagram of an embodiment. As shown in FIG. 1, the overlay network 100 of a peer search network may be represented as a two-dimensional Cartesian space, i.e., a grid. It should be readily apparent to those skilled in the art that other dimensions and other spaces may be used. Each zone of the overlay network 100 includes a peer that owns the zone. For example, in FIG. 1, the black circles represent the owner nodes (e.g., peer search nodes 110-120) for their respective zones. For clarity's sake, not all zones show a node owner.

In an embodiment, information may be stored in the overlay network 100 as key pairs (not shown). Each key pair may comprise a vector and an address index. The address index may be the item of information, a pointer to the location of the item of information, or a combination thereof. The vector component of the key pair may indicate a location in the logical space of the overlay network 100. Accordingly, a key pair may then be stored in the node owner of the zone where the location falls in the overlay network 100.

As shown in FIG. 1, the key pair of DOC A, (v(DOC A), Y) may be routed to peer search node 110 for storage. The vector component, v(DOC A), of the key pair may be computed by applying any type of IR algorithms (e.g, VSM, LSI, etc.). The aggregation of key pairs at the peer search nodes (e.g., peer search nodes 110-120) may then form indices of similar information that is searchable. Accordingly, information may be placed in a controlled fashion to facilitate and improve querying by aggregating similar key pairs on a peer search node or in nearby neighboring nodes.

A profile may be generated from a received query based on LSI algorithms. The profile may then be routed to peer search node 115 to provide for a subscription service to a subscriber, i.e., provide documents that match the profile. The profile may be stored at peer search 115 and also routed to a selected group of the neighboring nodes for storage as a child profile. The neighboring nodes (shown collectively as 125 in FIG. 1) are selected based on the neighboring nodes falling within a profile radius, r, of the peer search node 115. The profile radius, r, may be determined on a user-specified threshold. For example, a threshold may be determined from a cosine of two representative semantic vectors of two peer search nodes. If the cosine is greater than 0.75, for instance, then the nodes are within the profile radius, r. As the profile is distributed to the selected group, each node applies the profile to the respective stored indices. For example, when peer search node 110 receives the child profile, peer search node 110 may determine DOC A matches the received child profile and may forward DOC A to the initiator of the profile, i.e., the subscriber.

As new information arrives within the peer search nodes of 120, the stored profile may be applied to the new information. For instance, when DOC B is published to peer search node 120 as a key pair, peer search node 120 may apply the stored child profile to DOC B. If DOC B matches the profile, the peer search node 120 may then forward DOC B to the subscriber. Accordingly, a subscriber may timely receive relevant information as soon as it is published.

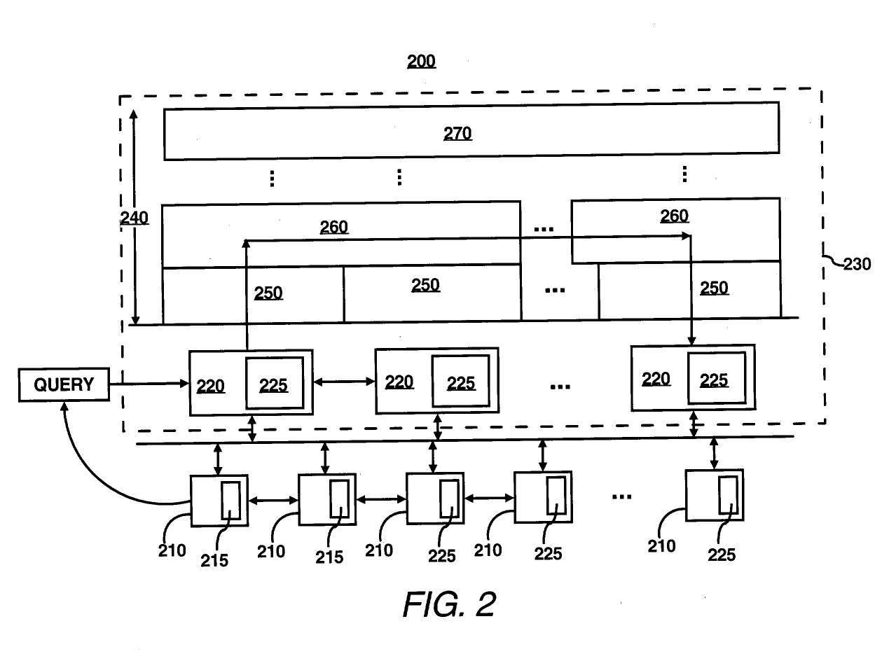

FIG. 2 illustrates an exemplary schematic diagram of an embodiment 200. As shown in FIG. 2, peers (or nodes) 210 may form a peer-to-peer network. Each peer of peers 210 may store and/or produce information (e.g., documents, data, web pages, etc.). The items of information may be stored in a dedicated storage device (e.g., mass storage) 215 accessible by the respective peer. The peers 210 may be computing platforms (e.g., personal digital assistants, laptop computers, workstations, and other similar devices) that have a network interface.

The peers 210 may be configured to exchange information among themselves and with other network nodes over a network (not shown). The network may be configured to provide a communication channel among the peers 210. The network may be implemented as a local area network, wide area network or combination thereof. The network may implement wired protocols such as Ethernet, token ring, etc., wireless protocols such as Cellular Digital Packet Data, Mobitex, IEEE 801.11b, Wireless Application Protocol, Global System for Mobiles, etc., or combination thereof.

A subset of the peers 210 may be selected as peer search nodes 220 to form a peer search network 230. The peer search network 230 may be a mechanism to permit controlled placement of key pairs within the peer search peers 220. In the peer search network 230, an item of information may be represented as indices comprised of key pairs. A key pair may comprise of the vector of an item of information and an address index of the item of information. The peers 210 may be configured to publish the key pairs to respective nodes where the vector falls within their zones. Accordingly, the peer search network 230 may then self-organize the key pairs based on the vector of the key pair.

When a query is received, a vector representation of the query may be formulated. For example, the LSI algorithm may be applied to the query to form the query vector. The query vector is then routed in the peer search network 230 to locate the requested information. Subsequently, after reaching the destination node indicated by the query vector, the query vector is then forwarded to neighboring nodes within a profile radius, r, of the destination node. Each of the neighboring nodes, including the destination node, may retrieve any information matching the query vector, filter the retrieved information to form a preselected set of information and forward the preselected information to the query initiator.

In another embodiment, the peer search network 230 may be configured to include an auxiliary overlay network 240 for routing. A hierarchal illustration of the auxiliary network 240 is shown in FIG. 2. A logical space formed by the peer search network 230 may be a d-torus, where d is the dimension of the logical space. The logical space is divided into fundamental (or basic) zones 250 where each node of the subset is the peers is an owner. Additional zones 260, 270 are formed over the fundamental zones to provide expressway routing of key pairs and queries.

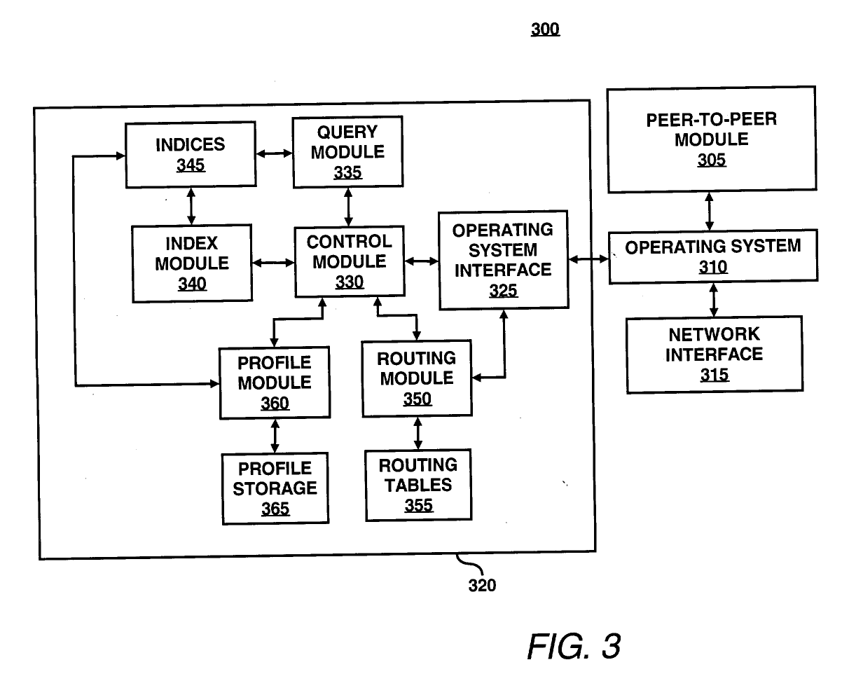

FIG. 3 illustrates an exemplary architecture 300 for the peer search node 220 shown in FIG. 2 in accordance with an embodiment. It should be readily apparent to those of ordinary skill in the art that the architecture 300 depicted in FIG. 3 represents a generalized schematic illustration and that other components may be added or existing components may be removed or modified. Moreover, the architecture 300 may be implemented using software components, hardware components, or a combination thereof.

As shown in FIG. 3, the architecture 300 may include a peer-to-peer module 305, an operating system 310, a network interface 315, and a peer search module 320. The peer-to-peer module 305 may be configured to provide the capability to a user of a peer to share information with another peer, i.e., each peer may initiate a communication session with another peer. The peer-to-peer module 305 may be a commercial off-the-shelf application program, a customized software application or other similar computer program. Such programs such as KAZAA, NAPSTER, MORPHEUS, or other similar P2P applications may implement the peer-to-peer module 305.

The peer search module 320 may be configured to monitor an interface between the peer-to-peer module 305 and the operating system 315 through an operating system interface 325. The operating system interface 310 may be implemented as an application program interface, a function call or other similar interfacing technique. Although the operating system interface 325 is shown to be incorporated within the peer search module 320, it should be readily apparent to those skilled in the art that the operating system interface 325 may also incorporated elsewhere within the architecture of the peer search module 320.

The operating system 310 may be configured to manage the software applications, data and respective hardware components (e.g., displays, disk drives, etc.) of a peer. The operating system 310 may be implemented by the MICROSOFT WINDOWS family of operating systems, UNIX, HEWLETT-PACKARD HP-UX, LINUX, RIM OS, and other similar operating systems.

The operating system 310 may be further configured to couple with the network interface 315 through a device driver (not shown). The network interface 315 may be configured to provide a communication port for the respective peer over a network. The network interface 315 may be implemented using a network interface card, a wireless interface card or other similar input/output device.

The peer search module 320 may also include a control module 330, a query module 335, an index module 340, at least one index (shown as ‘indices’ in FIG. 3) 345, a routing module 350, and a profile module 360. As previously noted, the peer search module 320 may be configured to implement the peer search network for the controlled placement and querying of key pairs in order to facilitate searching for information. The peer search module 320 may be implemented as a software program, a utility, a subroutine, or other similar programming entity. In this respect, the peer search module 320 may be implemented using software languages such as C, C++, JAVA, etc. Alternatively, the peer search module 320 may be implemented as an electronic device utilizing an application specific integrated circuit, discrete components, solid-state components or combination thereof.

The control module 330 of the peer search module 320 may provide a control loop for the functions of the peer search network. For example, if the control module 330 determines that a query message has been received, the control module 330 may forward the query message to the query module 335.

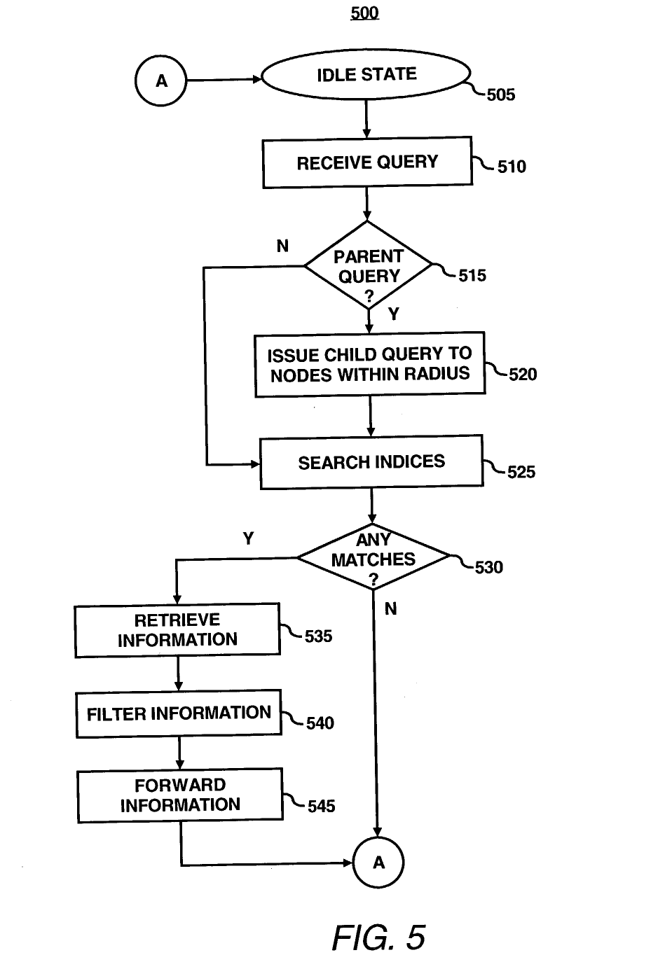

The query module 335 may be configured to provide a mechanism to respond to queries from peers (e.g., peers 110) or other peer search nodes (e.g., 120). As discussed above and in further detail with respect to FIG. 5, the query module 335 may respond to a query for information by determining whether the received query is a parent query or a child query. The child query is a parent query with a flag set to indicate that it is a child query. The flag provides a mechanism to avoid proliferation of queries. If the received query is a parent query, the query is forwarded to the neighboring nodes within the radius. Otherwise, the query module 335 may be configured to search the indices 345 for any matching key pairs. If there are matching key pairs, the query module 335 may retrieve the indexed information as pointed by the address index in the matching key pair. The query module 335 may then rank the retrieved information by applying IR techniques to form a ranked (or filtered) preselected set of information. The preselected set of information is then forwarded to the initiator of the query. If there are no matching key pairs, the query module 335 may hibernate till the next query is received.

The indices 345 may contain a database of similar key pairs as an index. There may be a plurality of indices associated with each peer search node. In one embodiment, a peer search node may be assigned multiple terms, thus the indices 345 may contain a respective index for each term. The indices 345 may be maintained as a linked-list, a look-up table, a hash table, database or other searchable data structure.

The index module 340 may be configured to create and maintain the indices 345. In one embodiment, the index module 340 may receive key pairs published by peers (e.g., peers 210 in FIG. 2). In another embodiment, the index module 340 may actively retrieve, i.e., ‘pull’, information from the peers. The index module 340 may also apply the vector algorithms to the retrieved information and form the key pairs for storage in the indices 345.

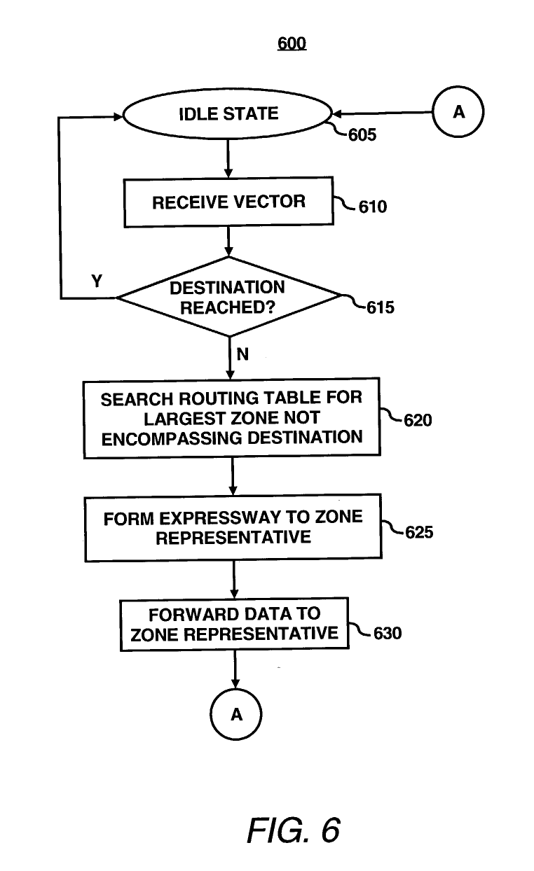

The control module 330 may also be interfaced with the routing module 350. The routing module 350 may be configured to provide expressway routing for query vectors and key pairs. Further detail of the operation of the routing module 350 is described with respect to FIG. 6.

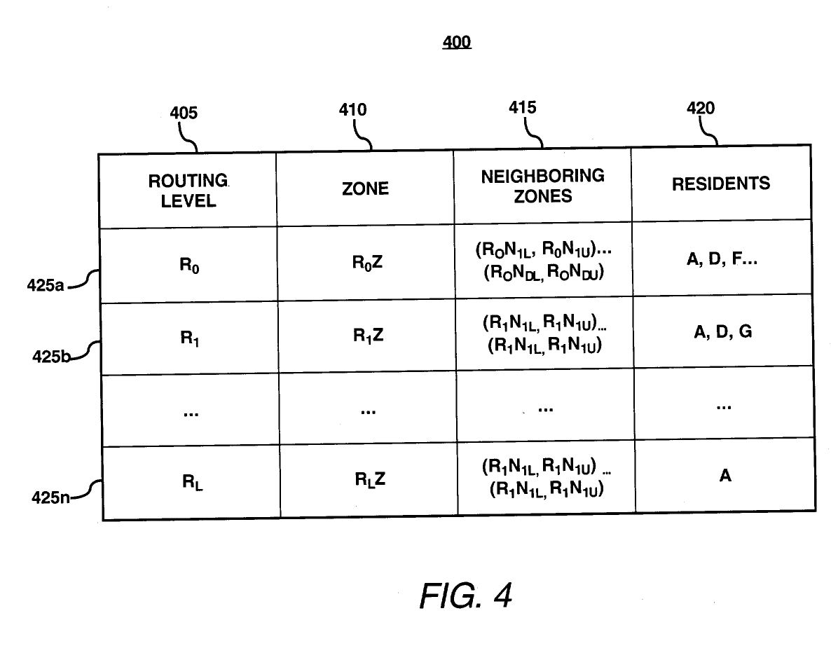

The routing module 350 may access routing table 355 (shown in FIG. 3) to implement expressway routing. FIG. 4 illustrates an exemplary diagram of the routing table 355 in accordance with an embodiment. It should be readily apparent to those of ordinary skill in the art that the routing table 355 depicted in FIG. 4 represents a generalized illustration and that other fields may be added or existing fields may be removed or modified.

As shown in FIG. 4, the routing table 355 may include a routing level field 405, a zone field 410, a neighboring zones field 415, and a resident field 420. In one embodiment, the values in the routing level field 405, the zone field 410, the neighboring zones 415, and the resident field 420 are associated or linked together in each entry of the entries 425a . . . n.

A value in the routing level field 405 may indicate the span the between zone representatives. The range of values for the level of the zone may range from the current unit of the overlay network (R₀) to the entire logical space of the P2P system (R₀). The largest value in the routing level field 405 may indicate the depth of the routing table as well as being the current table entry.

A value in the zone field 410 may indicate which zones the associated peer is aware thereof. Values in the neighboring zones field 415 indicate the identified neighbor zones to the peer. A neighbor zone may be determined by whether a zone shares a common border in the coordinate space; i.e., in a d-dimensional coordinate space, two nodes are neighbors if their coordinate spans overlap along d-1 dimensions and abut along one dimension.

Values in the resident fields 420 may indicate the identities of residents for the neighboring zones stored in the neighboring zones field 415. The values in residents field 420 may be indexed to the values the neighboring zones field 415 to associate the appropriate resident in the proper neighboring zone.

Returning to FIG. 3, the control module 330 may be configured to interface with the profile module 360. The profile module 360 may be configured to provide a subscription and publication service for a subscriber. More specifically, the profile module 360 may apply LSI algorithms to a receive query from the operating system interface 325 to form a profile for a subscriber. The profile module 360 may also set a timer to provide a limited service time for the subscription service. The profile module 360 may then forward the profile to the routing module 350 for routing to the appropriate peer search node.

The profile module 360 may also receive a profile and search the indices 345 for any matching information. If there is any matching information, the profile module 360 may forward the information to the routing module 350 for return to the subscriber. Otherwise, the profile module 360 may store the received profile in profile storage module 365. The profile module 360 may also determine a group of neighboring nodes to forward the profile based on the neighboring nodes being within a profile radius, r. Subsequently, for the nodes storing profiles, the profile module 360 may apply the profiles stored in the profile storage module 360 to newly arriving information to filter for relevant information as designated by the subscribers.

FIG. 5 illustrates an exemplary flow diagram 500 for the query module 335 (shown in FIG. 3) according to an embodiment. It should be readily apparent to those of ordinary skill in the art that this method 500 represents a generalized illustration and that other steps may be added or existing steps may be removed or modified.

As shown in FIG. 5, the query module 335 may be in an idle state, in step 505. The control module 425 may invoke a function call to the query module 335 based on detecting a query from the operating system interface 320.

In step 510, the query module 335 may receive a query vector. The query vector may be stored in a temporary memory location for processing.

In step 515, the query module 335 may determine whether the received query vector is a parent query. If the query module 335 determines that the received query vector is not a parent query, i.e., a child query, the query module 335 may proceed to the processing of step 525, which is discussed below. Otherwise, if the query module 335 determines that the received query vector is a parent query, the query module 335 may forward the received query vector to the nodes that are within a radius. The radius may be a user-specified characteristic, a network tunable characteristic, or combination thereof. The query module 335 may also mark or set a flag in the forwarded query vector to indicate its status as a child query.

In step 525, the query module 335 may search may search the indices 340 with the received query as a search term, in step 525. If the query module 335 determines that there are no matching key pairs in the indices 345, in step 530, the query module 335 may return to the idle state of step 505.

Otherwise, if the query module 335 determines there are matching key pairs, in step 530, the query module 335 may retrieve the information as pointed by the respective address index of the matching key pairs, and store the matching information in a temporary storage area, in step 535. The query module 335 may then rank the matching information by applying LSI algorithms to form a preselected set of information, in step 540. The query module 335 may forward the ranked set of matching key pairs to the initiator of the query, in step 545. Subsequently, the query module 335 may return to the idle state of step 505.

FIG. 6 illustrates an exemplary flow diagram for a method 600 of the routing module 350 shown in FIG. 3 in accordance with another embodiment. It should be readily apparent to those of ordinary skill in the art that this method 600 represents a generalized illustration and that other steps may be added or existing steps may be removed or modified.

As shown in FIG. 6, the routing module 350 of the peer search module 230 may be configured to be in an idle state in step 605. The routing module 350 may monitor the network interface 315 via the operating system 320 (shown in FIG. 3) for any received requests to route data. The requests may be initiated by a user of a peer or the requests may be forwarded to the receiving peer functioning as an intermediate peer. Alternatively, the requests to route may be received from the query module 330 as described above with respect to FIG. 6.

In step 610, the routing module 350 may received the semantic (or parameter) vector. In step 615, the routing module 350 determines whether the request has reached its destination. If the destination is the receiving peer, the routing module 350 may return to the idle state of step 605.

Otherwise, in step 620, the routing module 350 may be configured to search the routing table 355 for a largest zone not encompassing the semantic vector. It should be noted that the largest zone that does not encompass the destination can always be found, given the way the zones are determined as described above.

In step 625, the routing module 350 may be configured to form a communication channel, i.e., an expressway, to the zone representative of the destination zone at the level of the largest zone. The routing module 350 may forward the requested data to the zone representative in the destination zone in step 630. The zone representative will then forward the data to the destination peer. Subsequently, the routing module 350 may return to the idle state of step 605.

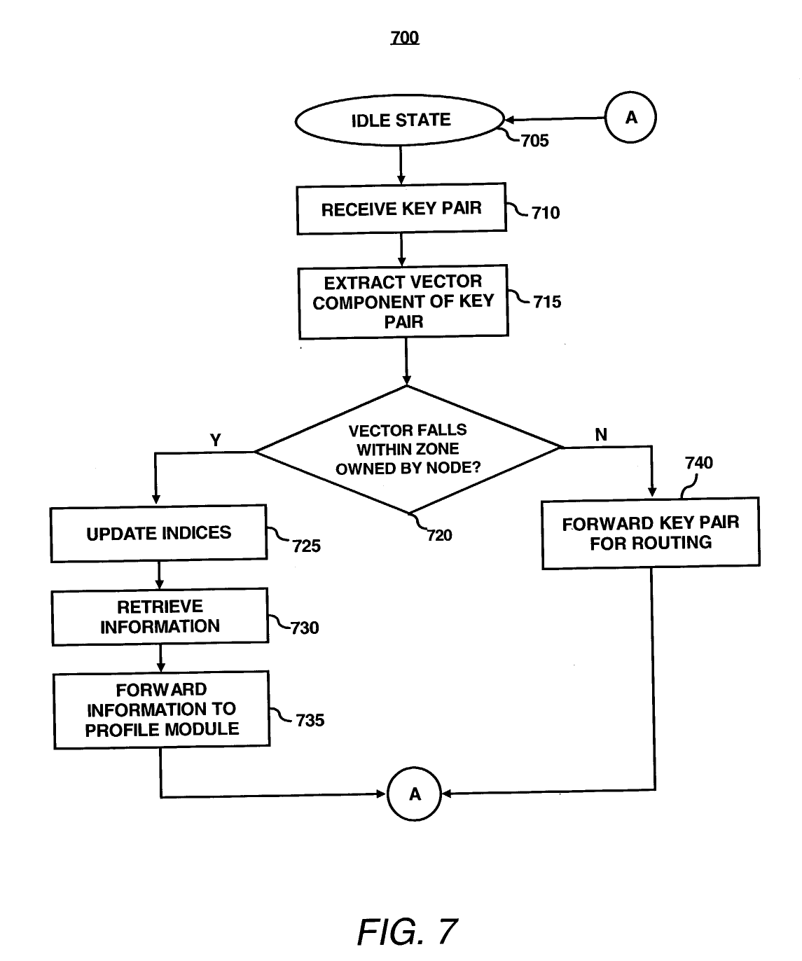

FIG. 7 illustrates an exemplary embodiment of a method 700 of the index module 340 shown in FIG. 3 in accordance with an embodiment. It should be readily apparent to those of ordinary skill in the art that this method 700 represents a generalized illustration and that other steps may be added or existing steps may be removed or modified.

As shown in FIG. 7, the index module 340 may be in an idle state, in step 705. The control module 325 may detect the receipt of a key pair through the network interface 515 through the operating system interface 320. The control module 325 may be configured to forward or invoke the index module 340.

In step 710, the index module 340 may be configured to receive the key pair. The index module 340 may store the key pair in a temporary memory location. In step 715, the vector component of the key pair is extracted.

In step 720, the index module 340 may determine if the vector falls within the zone owned by the node. If so, the index module may update the indices stored on this node.

If the key pair falls within the zone owned by this current node, the index module 340 may update the indices with the received key pair, in step 725. The index module 340 may be configured to retrieve the information associated with the key pair based on the associated address index, in step 730.

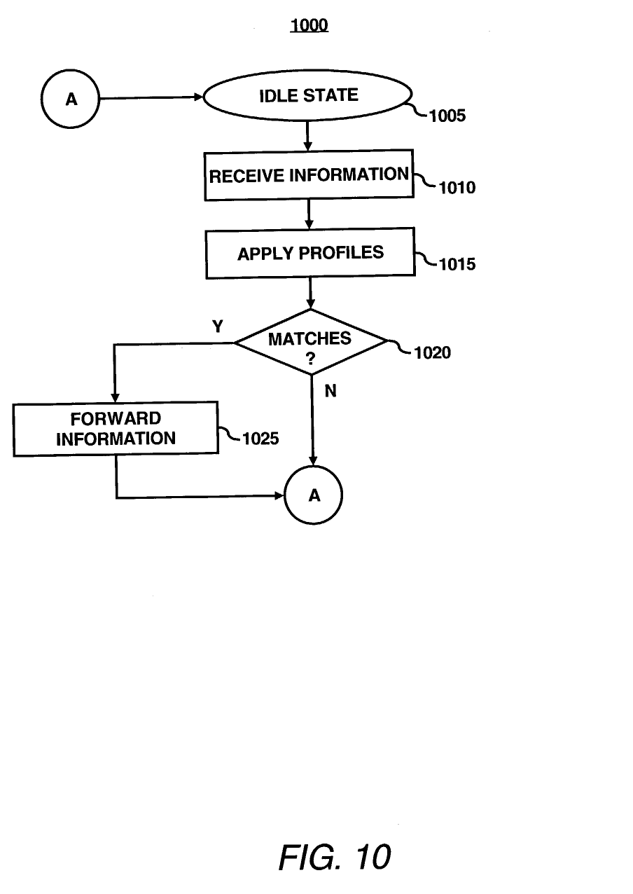

In step 735, the index module 340 may forward the information to the profile module 360 and the profile module 360 will invoke the processing associated with FIG. 10. Subsequently, the index module 340 may return to the idle state of step 705. Otherwise, the index module 340 may forward the received key pair to the routing module 345 for routing, in step 740. Subsequently, the index module 340 may return to the idle state of step 705.

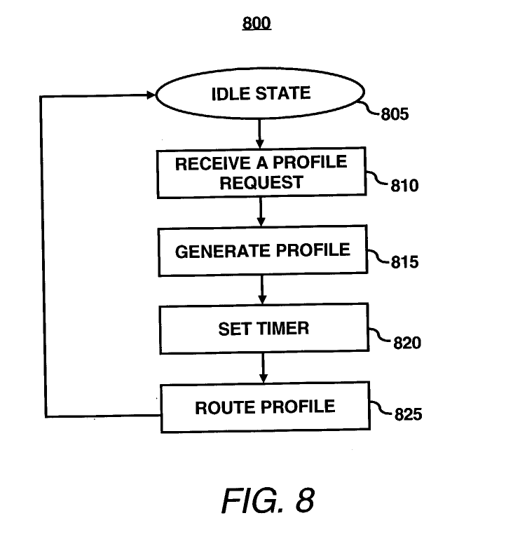

FIG. 8 illustrates an exemplary flow diagram for a method 800 of the profile module 360 as a subscriber in accordance with an embodiment. It should be readily apparent to those of ordinary skill in the art that this method 800 represents a generalized illustration and that other steps may be added or existing steps may be removed or modified.

As shown in FIG. 8, the profile module 360 may be in an idle state in step 805. The profile module 360 may receive a request for a profile request through the operating system interface 325, in step 810. The profile module 360 may convert the received request into profile by applying LSI or other similar IR algorithms to the received request, in step 815.

In step 820, the profile module 360 may set a timer associated with the profile. The timer provides a mechanism to terminate the profile, i.e., provide a limited time of operation, at a user's discretion.

In step 825, the profile module 360 may forward the profile to the routing module 360 for routing as described with respect to FIG. 6. Subsequently, the profile module 360 may return to the idle state of step 805.

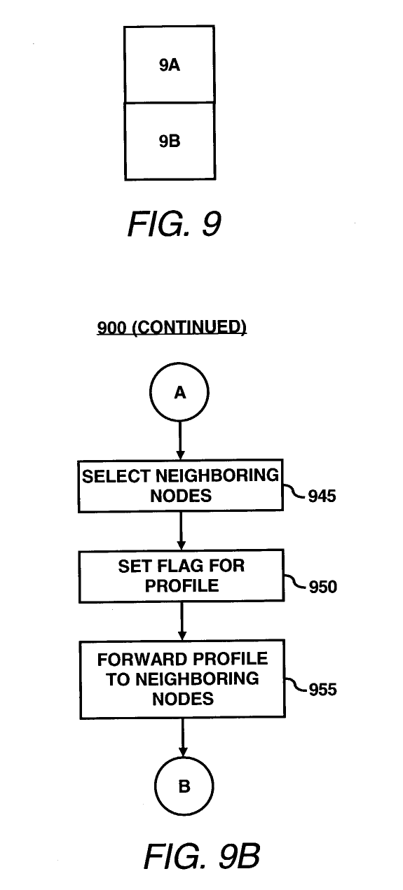

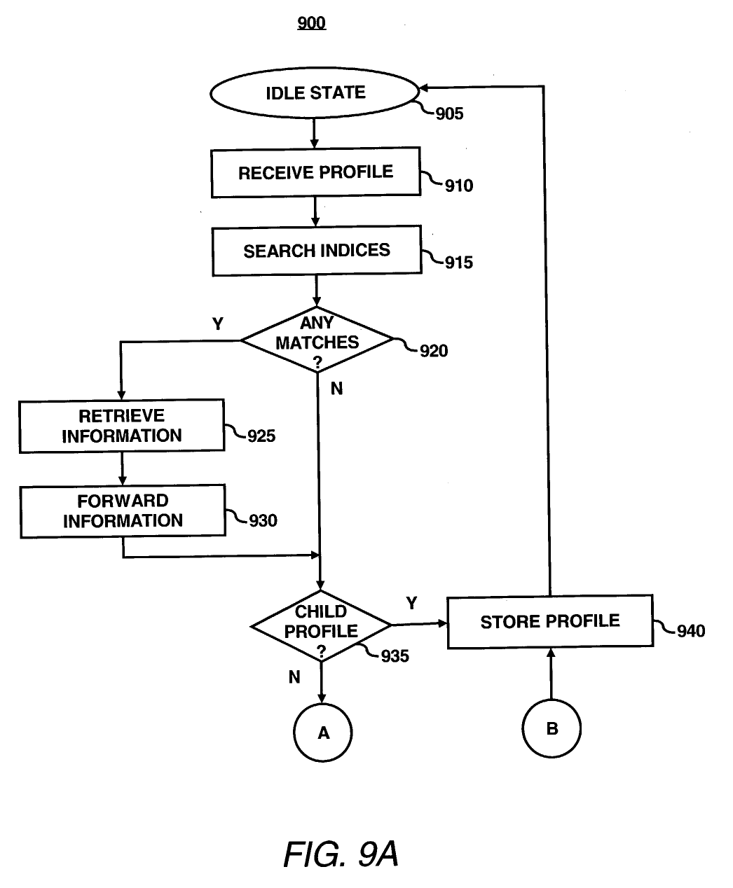

FIGS. 9A-B collectively illustrate an exemplary flow diagram for a method 900 of the profile module 360 as a subscriber provider in accordance with an embodiment. It should be readily apparent to those of ordinary skill in the art that this method 900 represents a generalized illustration and that other steps may be added or existing steps may be removed or modified.

As shown in FIG. 9, the profile module 360 may be in an idle state in step 905. The profile module 360 may receive a request for a profile request through the operating system interface 325, in step 910.

In step 915, the profile module 360 may search the indices 345 for key pairs that match the received profile. Any matching key pairs may be temporarily stored. In step 920, the profile module 360 determines whether any matching key pair was found. If no matching key pair was found, the profile module 360 may be configured to proceed to the processing of step 935.

Otherwise, if at least one matching key pair was found, in step 920, the profile module 360 may be configured to retrieve the associated information based on the address indices of the matching key pairs, in step 925. The information is then forwarded to the subscriber through the routing module 350, in step 930.

In step 935, the profile module 360 determines whether the received profile is a child profile by checking a child flag associated with the profile. If the child flag is set, the profile module 360 may be configured to store the received profile in the profile storage module 360. Subsequently, the profile module 360 may return to the idle state of step 905.

Otherwise, with respect to FIG. 9B, if the child flag is not set, the profile module 360 may be configured to select a group of neighboring nodes within a profile radius r, in step 945.

In step 950, the profile module 360 may be configured to set the child flag associated with the profile. The child flag provides a mechanism to prevent proliferation of profiles, thus ensuring that the profile stays within the profile radius.

In step 955, the profile module 360 may be configured to forward profile with the set child flag to the selected group of neighboring nodes through the routing module 350. Subsequently, with respect to FIG. 9A, the profile module 360 may return to the processing of step 940.

FIG. 10 illustrates an exemplary flow diagram for a method 1000 of the profile module 360 as a subscriber provider in accordance with an embodiment. It should be readily apparent to those of ordinary skill in the art that this method 1000 represents a generalized illustration and that other steps may be added or existing steps may be removed or modified.

As shown in FIG. 10, the profile module 360 may be in an idle state in step 1005. The profile module 360 may receive information from the index module 335, in step 1010.

In step 1015, the profile module 360 may be configured to retrieve the stored profiles from the profile storage module 365 and apply the profiles to the received information to determine if any of the stored profiles match the received information. Any profiles that matched the received information may be stored temporarily for further processing.

Optionally, the profile module 360 may determine whether any of the timers associated with the stored profiles have expired. If the any of the profiles have expired, the expired profile may be removed from the profile storage module 360. The subscriber may be sent a message informing of the expiration of the profile. In other embodiments, the check of the stored profiled may be conducted as part of a diagnostic routine.

In step 1020, the profile module 360 may determine whether the received information matches any of the profiles. In an embodiment, a cosine between a profile and the vector component of the information may be determined. The cosine may then be compared to a user-specified threshold. If the cosine is within the user-threshold, the profile matches the information. For all the matching profiles, the information may then be provided to the subscriber thought the routing module 350, in step 1025. Subsequently, the profile module 360 may return to the idle state of step 1005. Otherwise, if no matching profiles exists, in step 1020, the profile module 360 may return to the idle state of step 1005.

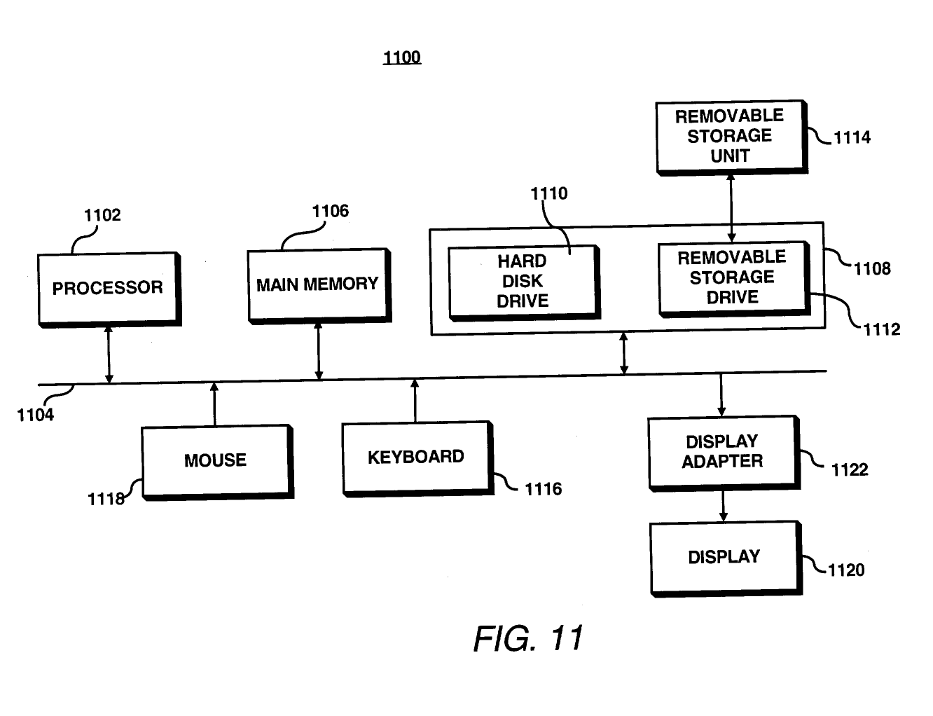

FIG. 11 illustrates an exemplary block diagram of a computer system 1100 where an embodiment may be practiced. The functions of the range query module may be implemented in program code and executed by the computer system 1100. The expressway routing module may be implemented in computer languages such as PASCAL, C, C++, JAVA, etc.

As shown in FIG. 11, the computer system 1100 includes one or more processors, such as processor 1102, that provide an execution platform for embodiments of the expressway routing module. Commands and data from the processor 1102 are communicated over a communication bus 1104. The computer system 1100 also includes a main memory 1106, such as a Random Access Memory (RAM), where the software for the range query module may be executed during runtime, and a secondary memory 1108. The secondary memory 1108 includes, for example, a hard disk drive 1110 and/or a removable storage drive 1112, representing a floppy diskette drive, a magnetic tape drive, a compact disk drive, etc., where a copy of a computer program embodiment for the range query module may be stored. The removable storage drive 1112 reads from and/or writes to a removable storage unit 114 in a well-known manner. A user interfaces with the expressway routing module with a keyboard 1116, a mouse 1118, and a display 1120. The display adaptor 1122 interfaces with the communication bus 1104 and the display 1120 and receives display data from the processor 1102 and converts the display data into display commands for the display 1120.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of providing information in a peer-to-peer network, said method comprising:
receiving a query;
generating a profile based on applying a latent semantic indexing algorithm to said query; and
routing said profile to a selected node based on said profile falling within a zone owned by said selected node.

2. The method according to claim 1, further comprising:
providing information based on arriving documents matching said profile.

3. The method according to claim 1, further comprising:
selecting a group of neighboring nodes based on said group of neighboring nodes falling within a radius of said selected node.

4. The method according to claim 3, further comprising:
selecting said radius based on a user-specified similarity threshold.

5. The method according to claim 1, further comprising:
setting a timer associated with said profile.

6. The method according to claim 5, further comprising:
deleting said profile based on said timer expiring.

7. The method according to claim 1, further comprising:
implementing an overlay network by a group of peers of said peer-to-peer network; and
dividing said overlay network into zones, each peer of said group of peers owning a respective node.

8. The method according to claim 7, further comprising:
storing key pairs, each key pair comprising a semantic vector and an associated address index, in said overlay network.

9. The method according to claim 8, further comprising:
creating groups of similar key pairs from said key pairs, each group of key pairs based on respective semantic vector of each key pair being similar.

10. The method according to claim 9, further comprising:
associating each group of similar key pairs with a respective peer of said overlay network.

11. An apparatus for providing information in a peer-to-peer network, said apparatus comprising:
means for implementing an overlay network by a group of peers of said peer-to-peer network;
means for dividing said overlay network into zones, each peer of said group of peers owning a respective node;
means for generating a profile based on applying a latent semantic indexing algorithm on a received query; and
means for routing said profile to a selected peer based on said profile falling within a respective of said selected peer.

12. The apparatus according to claim 11, further comprising:
means for providing information based on arriving documents matching said profile.

13. The apparatus according to claim 11, further comprising:
means for selecting a group of neighboring nodes based on said group of neighboring nodes falling within a radius of said selected node.

14. The apparatus according to claim 13, further comprising:
means for selecting said radius based on a user-specified similarity threshold.

15. The apparatus according to claim 11, further comprising:
means for setting a timer associated with said profile.

16. The apparatus according to claim 15, further comprising:
deleting said profile based on said timer expiring.

17. A system for providing information in a peer-to-peer network, said system comprising:
a plurality of peers;
an overlay network implemented by said plurality of peers, wherein said overlay network is configured to be divided into zones, each zone owned by a respective peer of said plurality of peers;
a plurality of indices, each index of said plurality of indices based on at least one key pair comprising a respective semantic vector and associated address index; and
a profile module stored an executed by each peer of said plurality of peers, wherein said profile module is configured to store a profile and to apply said profile to arriving information.

18. The system according to claim 17, wherein said profile module is further configured to determine a matching document based on said arriving information being similar to said profile.

19. The system according to claim 18, wherein said profile module is further configured to forward said matching information to an initiator of said received query.

20. The system according to claim 17, wherein said profile module is further configured to determine a matching document based on said arriving information matching said profile.

21. The system according to claim 17, wherein said profile module is further configured to select a group of neighboring nodes based on each neighboring node being within a radius.

22. The system according to claim 21, wherein a length of said radius is based on a similarity threshold.

23. A computer readable storage medium on which is embedded one or more computer programs, said one or more computer programs implementing a method of for providing information in a peer-to-peer network, said one or more computer programs comprising a set of instructions for:
receiving a query;
generating a profile based on applying a latent semantic indexing algorithm to said query; and
routing said profile to a selected node based on said profile falling within a zone owned by said selected node.

24. The computer readable storage medium in according to claim 23, said set of instructions further comprises:
providing information based on arriving documents matching said profile.

25. The computer readable storage medium in according to claim 23, said set of instructions further comprises:
selecting a group of neighboring nodes based on said group of neighboring nodes falling within a radius of said selected node.

26. The computer readable storage medium in according to claim 25, said set of instructions further comprises:
selecting said radius based on a user-specified similarity threshold.

27. The computer readable storage medium in according to claim 23, said set of instructions further comprises:
setting a timer associated with said profile.

28. The computer readable storage medium in according to claim 27, said set of instructions further comprises:
deleting said profile based on said timer expiring.
